(19) United States
(12) Patent Application Publication
(10) Pub. No.: US 2025/0150102 A1
(43) Pub. Date: May 8, 2025

(54) FINE-TUNING METHOD OF TRUE TIME DELAY SYSTEM

(71) Applicant: RFCORE CO.,LTD., Gyeonggi-do (KR)

(72) Inventors: Sung-Young LEE, Gyeonggi-do (KR); Byeong-Gyu PARK, Gyeonggi-do (KR); Han-Sol PARK, Seoul (KR); Sang-Bong YOON, Gyeonggi-do (KR); Bok-Ju PARK, Chungcheongnam-do (KR)

(21) Appl. No.: 18/394,441

(22) Filed: Dec. 22, 2023

(30) Foreign Application Priority Data
Nov. 6, 2023 (KR) 10-2023-0151918

(51) Int. Cl. H04B 1/04; H04B 1/30; H04B 7/08

(52) U.S. Cl. CPC H04B 1/04; H04B 1/30; H04B 7/0828; H04B 2001/0433; H04B 2001/305

(57) ABSTRACT

A fine-tuning method of a true time delay system includes: a first reference unit for transmitting an applied RF signal without time delay; a first delay unit for transmitting the applied RF signal to be delayed as much as a first delay time; an input unit for transmitting the applied RF signal to the first reference unit or the first delay unit; a second reference unit for transmitting the RF signal transmitted from the first reference unit or the first delay unit without time delay; a second delay unit for transmitting the RF signal; a 12th switching unit for transmitting the RF signal transmitted from the first reference unit or the first delay unit to the second reference unit or the second delay unit; and an output unit for outputting the RF signal.

### BACKGROUND

The present invention relates to a fine-tuning method of a true time delay system, and more specifically, to a fine-tuning method of a true time delay system, which can control delay time at fine intervals while implementing a true time delay circuit employing MOS capacitors in a smaller area by configuring the true time delay circuit in multiple stages, and controlling delay time of each of the multi-stage true time delay circuits in multiple steps.

In an antenna system employing multiple phase array antennas, a phase required for beam steering is set for each of the multiple phased array antennas.

However, when the antenna system employing the phase array antennas described above is driven in a frequency band having a wide instantaneous bandwidth, such as millimeter wave 5G communication, a problem of seriously shifting the beam of steered RF signals may occur at the frequencies other than the frequency that sets the beam steering. For example, the instantaneous bandwidth of some millimeter wave 5G communication methods reaches up to 800 MHz on the basis of 28 GHz signals. That is, the 5G communication method with a center frequency of 28 GHZ may operate between 27.6 GHz and 28.4 GHz, and in this case, when the beam is set to be steered in a specific direction at 28 GHz, a beam shift phenomenon occurs at 27.6 GHz or 28.4 GHz, and the beam is steered in a direction other than the set direction.

Although a True Time Delay (TTD) device manufactured in a Complementary Metal Oxide Semiconductor (CMOS) process is employed to adjust the delay time of each of the multiple phase array antennas in order to solve the disadvantages described above, there is a problem in that when the number of phase array antennas increases, the area of the CMOS true time delay device increases, and the quality coefficient of the CMOS true time delay device decreases.

The background technology of the present invention is disclosed in Korean Patent Publication No. 10-2045498.

### SUMMARY OF THE INVENTION

Therefore, the present invention has been made in view of the above problems, and it is an object of the present invention to provide a fine-tuning method of a true time delay system, which can control delay time at fine intervals while implementing a true time delay circuit employing MOS capacitors in a smaller area by configuring the true time delay circuit in multiple stages, and controlling delay time of each of the multi-stage true time delay circuits in multiple steps.

The technical problems to be solved by the present invention are not limited to the technical problems mentioned above, and unmentioned other technical problems will be clearly understood by those skilled in the art from the following description.

To accomplish the above object, according to a first embodiment of the present invention, there is provided a fine-tuning method of a true time delay system, the system comprising: a first reference unit for transmitting an applied RF signal without time delay; a first delay unit for transmitting the applied RF signal to be delayed as much as a first delay time; an input unit for transmitting the applied RF signal to the first reference unit or the first delay unit; a second reference unit for transmitting the RF signal transmitted from the first reference unit or the first delay unit without time delay; a second delay unit for transmitting the RF signal transmitted from the first reference unit or the first delay unit to be delayed as much as a second delay time twice as long as the first delay time; a 12th switching unit for transmitting the RF signal transmitted from the first reference unit or the first delay unit to the second reference unit or the second delay unit; and an output unit for outputting the RF signal transmitted from the second reference unit or the second delay unit to the outside, wherein the first delay time may be controlled in multiple stages, and the second delay time may be controlled in multiple stages.

In the fine-tuning method of a true time delay system according to a first embodiment of the present invention, the first delay unit or the second delay unit may include a first MOS capacitor, an inductor, and a second MOS capacitor, wherein the source and the drain of the first MOS capacitor may be connected to the ground, the gate of the first MOS capacitor may be connected to the inductor, and the source and the drain of the second MOS capacitor may be connected to the ground, and the gate of the second MOS capacitor may be is connected to the inductor, and by adjusting magnitude of bias voltages applied to the gate of the first MOS capacitor and the gate of the second MOS capacitor, the first delay time or the second delay time may be controlled in multiple stages.

In the fine-tuning method of a true time delay system according to a first embodiment of the present invention, a first capacitor may be disposed between the input unit and the first delay unit to suppress transmission of a signal of a Direct Current (DC) component to the first delay unit, and a 12th capacitor may be disposed between the first delay unit and the second delay unit to suppress transmission of a signal of a Direct Current (DC) component to the second delay unit.

To accomplish the above object, according to a second embodiment of the present invention, there is provided a fine-tuning method of a true time delay system, the system comprising: a first reference unit for transmitting an applied RF signal without time delay; a first delay unit for transmitting the applied RF signal to be delayed as much as a first delay time; an input unit for transmitting the applied RF signal to the first reference unit or the first delay unit; a second reference unit for transmitting the RF signal transmitted from the first reference unit or the first delay unit without time delay; a second delay unit for transmitting the RF signal transmitted from the first reference unit or the first delay unit to be delayed as much as a second delay time twice as long as the first delay time; a 12th switching unit for transmitting the RF signal transmitted from the first reference unit or the first delay unit to the second reference unit or the second delay unit; and an output unit for outputting the RF signal transmitted from the second reference unit or the second delay unit to the outside, wherein the first delay time may be controlled in multiple stages, and the second delay time may be controlled in fewer stages than the first delay time is controlled.

In the fine-tuning method of a true time delay system according to a second embodiment of the present invention, the first delay unit or the second delay unit may include a first MOS capacitor, an inductor, and a second MOS capacitor, wherein the source and the drain of the first MOS capacitor may be connected to the ground, the gate of the first MOS capacitor may be connected to the inductor, and the source and the drain of the second MOS capacitor may be connected to the ground, and the gate of the second MOS capacitor may be connected to the inductor, and by adjusting magnitude of bias voltage applied to the gate of the first MOS capacitor, the first delay time may be controlled in multiple stages, and by adjusting magnitude of bias voltage applied to the gate of the second MOS capacitor, the second delay time may be controlled in fewer stages than the first delay time is controlled.

In the fine-tuning method of a true time delay system according to a second embodiment of the present invention, a first capacitor may be disposed between the input unit and the first delay unit to suppress transmission of a signal of a Direct Current (DC) component to the first delay unit, and a 12th capacitor may be disposed between the first delay unit and the second delay unit to suppress transmission of a signal of a Direct Current (DC) component to the second delay unit.

To accomplish the above object, according to a third embodiment of the present invention, there is provided a fine-tuning method of a true time delay system, the method comprising: a first reference unit for transmitting an applied RF signal without time delay; a first delay unit for transmitting the applied RF signal to be delayed as much as a first delay time; an input unit for transmitting the applied RF signal to the first reference unit or the first delay unit; a second reference unit for transmitting the RF signal transmitted from the first reference unit or the first delay unit without time delay; a second delay unit for transmitting the RF signal transmitted from the first reference unit or the first delay unit to be delayed as much as a second delay time twice as long as the first delay time; a 12th switching unit for transmitting the RF signal transmitted from the first reference unit or the first delay unit to the second reference unit or the second delay unit; and an output unit for outputting the RF signal transmitted from the second reference unit or the second delay unit to the outside, wherein the first delay time may be controlled in multiple stages, and the second delay time may be controlled in more stages than the first delay time is controlled.

In the fine-tuning method of a true time delay system according to a third embodiment of the present invention, the first delay unit or the second delay unit may include a first MOS capacitor, an inductor, and a second MOS capacitor, wherein the source and the drain of the first MOS capacitor may be connected to the ground, the gate of the first MOS capacitor may be connected to the inductor, and the source and the drain of the second MOS capacitor may be connected to the ground, and the gate of the second MOS capacitor may be connected to the inductor, and by adjusting magnitude of bias voltage applied to the gate of the first MOS capacitor, the first delay time may be controlled in multiple stages, and by adjusting magnitude of bias voltage applied to the gate of the second MOS capacitor, the second delay time may be controlled in more stages than the first delay time is controlled.

In the fine-tuning method of a true time delay system according to a third embodiment of the present invention, a first capacitor may be disposed between the input unit and the first delay unit to suppress transmission of a signal of a Direct Current (DC) component to the first delay unit, and a 12th capacitor may be disposed between the first delay unit and the second delay unit to suppress transmission of a signal of a Direct Current (DC) component to the second delay unit.

To accomplish the above object, according to a fourth embodiment of the present invention, there is provided a fine-tuning method of a true time delay system, the system comprising: a first reference unit for transmitting an applied RF signal without time delay; a first delay unit for transmitting the applied RF signal to be delayed as much as a first delay time; an input unit for transmitting the applied RF signal to the first reference unit or the first delay unit; a second reference unit for transmitting the RF signal transmitted from the first reference unit or the first delay unit without time delay; a second delay unit for transmitting the RF signal transmitted from the first reference unit or the first delay unit to be delayed as much as a second delay time twice as long as the first delay time; a 12th switching unit for transmitting the RF signal transmitted from the first reference unit or the first delay unit to the second reference unit or the second delay unit; a third reference unit for transmitting the RF signal transmitted from the second reference unit or the second delay unit without time delay; a third delay unit for transmitting the RF signal transmitted from the second reference unit or the second delay unit to be delayed as much as a third delay time four times as long as the first delay time; a 23th switching unit for transmitting the RF signal transmitted from the second reference unit or the second delay unit to the third reference unit or the third delay unit; a fourth reference unit for transmitting the RF signal transmitted from the third reference unit or the third delay unit without time delay; a fourth delay unit for transmitting the RF signal transmitted from the third reference unit or the third delay unit to be delayed as much as a fourth delay time eight times as long as the first delay time; a 34th switching unit for transmitting the RF signal transmitted from the third reference unit or the third delay unit to the fourth reference unit or the fourth delay unit; a fifth reference unit for transmitting the RF signal transmitted from the fourth reference unit or the fourth delay unit without time delay; a fifth delay unit for transmitting the RF signal transmitted from the fourth reference unit or the fourth delay unit to be delayed as much as a fifth delay time sixteen times as long as the first delay time; a 45th switching unit for transmitting the RF signal transmitted from the fourth reference unit or the fourth delay unit to the fifth reference unit or the fifth delay unit; and an output unit for outputting the RF signal transmitted from the fifth reference unit or the fifth delay unit to the outside, wherein the first delay time may be controlled in multiple stages, the second delay time may be controlled in multiple stages, the third delay time may be controlled in multiple stages, the fourth delay time may be controlled in multiple stages, and the fifth delay time may be controlled in multiple stages.

In the fine-tuning method of a true time delay system according to a fourth embodiment of the present invention, the first delay unit, the second delay unit, the third delay unit, the fourth delay unit, or the fifth delay unit may include a first MOS capacitor, an inductor, and a second MOS capacitor, and the source and the drain of the first MOS capacitor may be connected to the ground, the gate of the first MOS capacitor may be connected to the inductor, the source and the drain of the second MOS capacitor may be connected to the ground, and the gate of the second MOS capacitor may be connected to the inductor, and by adjusting the magnitude of the bias voltages applied to the gate of the first MOS capacitor and the gate of the second MOS capacitor, the first delay time, the second delay time, the third delay time, the fourth delay time, or the fifth delay time may be controlled in multiple stages.

In the fine-tuning method of a true time delay system according to a fourth embodiment of the present invention, a first capacitor may be disposed between the input unit and the first delay unit to suppress transmission of a signal of a Direct Current (DC) component to the first delay unit, a 12th capacitor may be disposed between the first delay unit and the second delay unit to suppress transmission of a signal of a Direct Current (DC) component to the second delay unit, a 23th capacitor may be disposed between the second delay unit and the third delay unit to suppress transmission of a signal of a Direct Current (DC) component to the third delay unit, a 34th capacitor may be disposed between the third delay unit and the fourth delay unit to suppress transmission of a signal of a Direct Current (DC) component to the fourth delay unit, and a 45th capacitor may be disposed between the fourth delay unit and the fifth delay unit to suppress transmission of a signal of a Direct Current (DC) component to the fifth delay unit.

### BRIEF DESCRIPTION OF THE DRAWINGS

FIG. 1 is a circuit diagram showing a true time delay system performing a fine-tuning method of a true time delay system according to embodiments of the present invention.

FIG. 2 is a circuit diagram showing a delay unit of the true time delay system of FIG. 1.

### DETAILED DESCRIPTION OF THE PREFERRED EMBODIMENT

The detailed description of the present invention described below refers to the accompanying drawings, which show, by way of example, specific embodiments in which the present invention may be practiced. These embodiments are described in sufficient detail to allow those skilled in the art to practice the present invention. It should be understood that the various embodiments of the present invention are different from each other, but are not necessarily mutually exclusive.

For example, it should be understood that specific shapes, structures and characteristics described herein may be implemented in other embodiments in connection with one embodiment without departing from the principles of the present invention, and the location or arrangement of individual components within each disclosed embodiment may be changed without departing from the principles of the present invention.

Accordingly, the detailed description described below is not intended to be taken in a limiting sense, and the scope of the present invention is limited only by the appended claims, together with all equivalents asserted by the claims, when it is properly described.

Similar reference symbols in the drawings refer to identical or similar functions throughout several aspects, and the length, area, thickness, or the like may be exaggerated for convenience.

Additionally, when a part “includes” a certain component, this means that it may further include other components, rather than excluding other components, unless specifically stated otherwise.

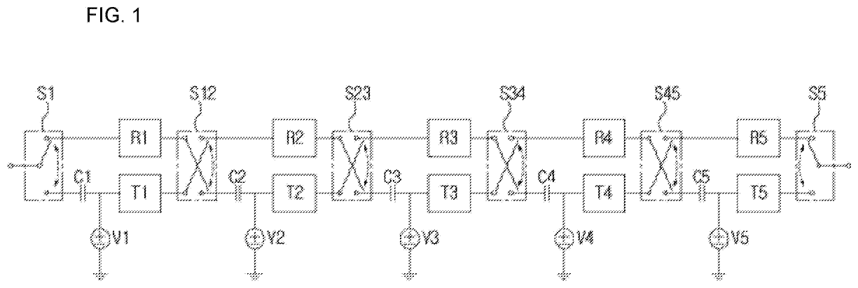

As shown in FIG. 1, a true time delay system performing a fine-tuning method of a true time delay system according to a first embodiment of the present invention includes a first reference unit R1 for transmitting an applied RF signal through a transmission line without time delay; a first delay unit T1 for transmitting the applied RF signal to be delayed as much as a first delay time; an input unit S1 for transmitting the applied RF signal to the first reference unit R1 or the first delay unit T1; a second reference unit R2 for transmitting the RF signal transmitted from the first reference unit R1 or the first delay unit T1 through a transmission line without time delay; a second delay unit T2 for transmitting the RF signal transmitted from the first reference unit R1 or the first delay unit T1 to be delayed as much as a second delay time twice as long as the first delay time; a 12th switching unit S12 for transmitting the RF signal transmitted from the first reference unit R1 or the first delay unit T1 to the second reference unit R2 or the second delay unit T2; and an output unit S5 for outputting the RF signal transmitted from the second reference unit R2 or the second delay unit T2 to the outside. Here, the first delay time is controlled in multiple stages, and the second delay time is controlled in multiple stages.

Specifically, when the first delay time is controlled in four stages of 0.5 psec, 1.0 psec, 1.5 psec, and 2.0 psec, and the second delay time is controlled in four stages of 1.0 psec, 2.0 psec, 3.0 psec, and 4.0 psec, the fine-tuning method of a true time delay system according to an embodiment of the present invention may precisely adjust the delay time in 16 (4×4) stages. The first delay time and the second delay time do not necessarily need to be controlled in four stages, and may be changed to be controlled in two stages or eight stages as needed.

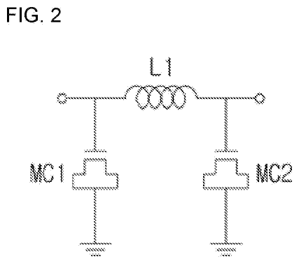

Here, the first delay unit T1 or the second delay unit T2 includes a first MOS capacitor MC1, an inductor L1, and a second MOS capacitor MC2 as shown in FIG. 2, and the source and the drain of the first MOS capacitor MC1 are connected to the ground, the gate of the first MOS capacitor MC1 is connected to the inductor L1, the source and the drain of the second MOS capacitor MC2 are connected to the ground, and the gate of the second MOS capacitor MC2 is connected to the inductor L1.

Meanwhile, by adjusting the magnitude of the bias voltages V1 and V2 applied to the gate of the first MOS capacitor MC1 and the gate of the second MOS capacitor MC2, the first delay time or the second delay time may be controlled in multiple stages.

Here, a first capacitor C1 may be disposed between the input unit S1 and the first delay unit T1 to suppress transmission of a signal of a Direct Current (DC) component to the first delay unit T1, and a 12th capacitor C2 may be disposed between the first delay unit T1 and the second delay unit T2 to suppress transmission of a signal of a Direct Current (DC) component to the second delay unit T2.

As the first capacitor C1 and the 12th capacitor C2 described above are disposed, the first delay unit T1 may be less affected by the bias voltage V2 of the second delay unit T2, and the second delay unit T2 may be less affected by the bias voltage V1 of the first delay unit T1.

Hereinafter, a fine-tuning method of a true time delay system according to a second embodiment of the present invention will be described, and mainly the differences from the fine-tuning method of a true time delay system according to a first embodiment of the present invention will be described.

In the fine-tuning method of a true time delay system according to a second embodiment of the present invention, the first delay time is controlled in multiple stages, and the second delay time is controlled in fewer stages than the first delay time is controlled.

Specifically, the first delay time is controlled in four stages of 0.5 psec, 1.0 psec, 1.5 psec, and 2.0 psec, and the second delay time is controlled in two stages of 2.0 psec and 4.0 psec.

The fine-tuning method of a true time delay system according to a second embodiment of the present invention may adjust time delay more precisely when the provided delay time is short, rather than when the provided delay time is long.

Hereinafter, a fine-tuning method of a true time delay system according to a third embodiment of the present invention will be described, and mainly the differences from the fine-tuning method of a true time delay system according to a first embodiment of the present invention will be described.

In the fine-tuning method of a true time delay system according to a third embodiment of the present invention, the first delay time is controlled in multiple stages, and the second delay time is controlled in more stages than the first delay time is controlled.

Specifically, the first delay time is controlled in two stages of 1.0 psec and 2.0 psec, and the second delay time is controlled in four stages of 1.0 psec, 2.0 psec, 3.0 psec, and 4.0 psec.

The fine-tuning method of a true time delay system according to a third embodiment of the present invention may adjust time delay more precisely when the provided delay time is long, rather than when the provided delay time is short. As shown in FIG. 1, a true time delay system performing a fine-tuning method of a true time delay system according to a fourth embodiment of the present invention includes a first reference unit R1 for transmitting an applied RF signal without time delay; a first delay unit T1 for transmitting the applied RF signal to be delayed as much as a first delay time; an input unit S1 for transmitting the applied RF signal to the first reference unit R1 or the first delay unit T1; a second reference unit R2 for transmitting the RF signal transmitted from the first reference unit R1 or the first delay unit T1 without time delay; a second delay unit T2 for transmitting the RF signal transmitted from the first reference unit R1 or the first delay unit T1 to be delayed as much as a second delay time twice as long as the first delay time; a 12th switching unit S12 for transmitting the RF signal transmitted from the first reference unit R1 or the first delay unit T1 to the second reference unit R2 or the second delay unit T2; a third reference unit R3 for transmitting the RF signal transmitted from the second reference unit R2 or the second delay unit T2 without time delay; a third delay unit T3 for transmitting the RF signal transmitted from the second reference unit R2 or the second delay unit T2 to be delayed as much as a third delay time four times as long as the first delay time; a 23th switching unit S23 for transmitting the RF signal transmitted from the second reference unit R2 or the second delay unit T2 to the third reference unit R3 or the third delay unit T3; a fourth reference unit R4 for transmitting the RF signal transmitted from the third reference unit R3 or the third delay unit T3 without time delay; a fourth delay unit T4 for transmitting the RF signal transmitted from the third reference unit R3 or the third delay unit T3 to be delayed as much as a fourth delay time eight times as long as the first delay time; a 34th switching unit S34 for transmitting the RF signal transmitted from the third reference unit R3 or the third delay unit T3 to the fourth reference unit R4 or the fourth delay unit T4; a fifth reference unit R5 for transmitting the RF signal transmitted from the fourth reference unit R4 or the fourth delay unit T4 without time delay; a fifth delay unit T5 for transmitting the RF signal transmitted from the fourth reference unit R4 or the fourth delay unit T4 to be delayed as much as a fifth delay time sixteen times as long as the first delay time; a 45th switching unit S45 for transmitting the RF signal transmitted from the fourth reference unit R4 or the fourth delay unit T4 to the fifth reference unit R5 or the fifth delay unit T5; and an output unit S5 for outputting the RF signal transmitted from the fifth reference unit R5 or the fifth delay unit T5 to the outside.

Here, the true time delay system performing a fine-tuning method of a true time delay system according to a fourth embodiment of the present invention does not necessarily need to configure the delay unit in five stages, and may also configure in three stages or four stages.

Meanwhile, the first delay time is controlled in multiple stages, the second delay time is controlled in multiple stages, the third delay time is controlled in multiple stages, the fourth delay time is controlled in multiple stages, and the fifth delay time is controlled in multiple stages.

Specifically, when the first delay time is controlled in four stages of 0.5 psec, 1.0 psec, 1.5 psec, and 2.0 psec, the second delay time is controlled in four stages of 1.0 psec, 2.0 psec, 3.0 psec, and 4.0 psec, the third delay time is controlled in four stages of 2.0 psec, 4.0 psec, 6.0 psec and 8.0 psec, the fourth delay time is controlled in four stages of 4.0 psec, 8.0 psec, 12.0 psec and 16.0 psec, and the fifth delay time is controlled in four stages of 8.0 psec, 16.0 psec, 24.0 psec and 32.0 psec, the fine-tuning method of a true time delay system according to an embodiment of the present invention may precisely adjust the delay time in 1,024 (4×4×4×4×4) stages. The first delay time, the second delay time, the third delay time, the fourth delay time, and the fifth delay time do not necessarily need to be controlled in four stages, and may be changed to be controlled in two stages or eight stages as needed.

Meanwhile, in the fine-tuning method of a true time delay system according to a fourth embodiment of the present invention, the first delay time may be controlled in two stages, the second delay time may be controlled in four stages, the third delay time may be controlled in eight stages, the fourth delay time may be controlled in sixteen stages, and the fifth delay time may be controlled in thirty-two stages.

In addition, in the fine-tuning method of a true time delay system according to a fourth embodiment of the present invention, the first delay time may be controlled in thirty-two stages, the second delay time may be controlled in sixteen stages, and the third delay time may be controlled in eight stages, the fourth delay time may be controlled in four stages, and the fifth delay time may be controlled in two stages.

Here, the first delay unit T1, the second delay unit T2, the third delay unit T3, the fourth delay unit T4, or the fifth delay unit T5 includes a first MOS capacitor MC1, an inductor L1, and a second MOS capacitor MC2, and the source and the drain of the first MOS capacitor MC1 are connected to the ground, the gate of the first MOS capacitor MC1 is connected to the inductor L1, the source and the drain of the second MOS capacitor MC2 are connected to the ground, and the gate of the second MOS capacitor MC2 is connected to the inductor L1.

Meanwhile, by adjusting the magnitude of the bias voltages V1, V2, V3, V4, and V5 applied to the gate of the first MOS capacitor MC1 and the gate of the second MOS capacitor MC2, the first delay time, the second delay time, the third delay time, the fourth delay time, or the fifth delay time may be controlled in multiple stages.

Here, a first capacitor C1 may be disposed between the input unit S1 and the first delay unit T1 to suppress transmission of a signal of a Direct Current (DC) component to the first delay unit T1, a 12th capacitor C2 may be disposed between the first delay unit T1 and the second delay unit T2 to suppress transmission of a signal of a Direct Current (DC) component to the second delay unit T2, a 23th capacitor C3 may be disposed between the second delay unit T2 and the third delay unit T3 to suppress transmission of a signal of a Direct Current (DC) component to the third delay unit T3, a 34th capacitor C4 may be disposed between the third delay unit T3 and the fourth delay unit T4 to suppress transmission of a signal of a Direct Current (DC) component to the fourth delay unit T4, and a 45th capacitor C5 may be disposed between the fourth delay unit T4 and the fifth delay unit T5 to suppress transmission of a signal of a Direct Current (DC) component to the fifth delay unit T5.

The fine-tuning methods of a true time delay system according to the embodiments of the present invention may control delay time at fine intervals while implementing a true time delay circuit employing MOS capacitors in a smaller area by configuring the true time delay circuit in multiple stages, and controlling delay time of each of the multi-stage true time delay circuits in multiple steps.

Although the present invention has been described and illustrated in connection with preferred embodiments for illustrating the principles of the present invention, the present invention is not limited to the configuration and operation as shown and described above.

Rather, those skilled in the art will understand that many changes and modifications can be made to the present invention without departing from the spirit and scope of the appended claims.

Accordingly, all such appropriate changes, modifications, and equivalents should be considered to fall within the scope of the present invention.

What is claimed is:

1. A fine-tuning method of a true time delay system, the system comprising:
a first reference unit for transmitting an applied RF signal without time delay;
a first delay unit for transmitting the applied RF signal to be delayed as much as a first delay time;
an input unit for transmitting the applied RF signal to the first reference unit or the first delay unit;
a second reference unit for transmitting the RF signal transmitted from the first reference unit or the first delay unit without time delay;
a second delay unit for transmitting the RF signal transmitted from the first reference unit or the first delay unit to be delayed as much as a second delay time twice as long as the first delay time;
a 12th switching unit for transmitting the RF signal transmitted from the first reference unit or the first delay unit to the second reference unit or the second delay unit; and
an output unit for outputting the RF signal transmitted from the second reference unit or the second delay unit to the outside, wherein
the first delay time is controlled in multiple stages, and the second delay time is controlled in multiple stages.

2. The method according to claim 1, wherein the first delay unit or the second delay unit includes a first MOS capacitor, an inductor, and a second MOS capacitor, wherein the source and the drain of the first MOS capacitor are connected to the ground, the gate of the first MOS capacitor is connected to the inductor, and the source and the drain of the second MOS capacitor are connected to the ground, and the gate of the second MOS capacitor is connected to the inductor, and by adjusting magnitude of bias voltages applied to the gate of the first MOS capacitor and the gate of the second MOS capacitor, the first delay time or the second delay time are controlled in multiple stages.

3. The method according to claim 2, wherein a first capacitor is disposed between the input unit and the first delay unit to suppress transmission of a signal of a Direct Current (DC) component to the first delay unit, and a 12th capacitor is disposed between the first delay unit and the second delay unit to suppress transmission of a signal of a Direct Current (DC) component to the second delay unit.

4. A fine-tuning method of a true time delay system, the system comprising:
a first reference unit for transmitting an applied RF signal without time delay;
a first delay unit for transmitting the applied RF signal to be delayed as much as a first delay time;
an input unit for transmitting the applied RF signal to the first reference unit or the first delay unit;
a second reference unit for transmitting the RF signal transmitted from the first reference unit or the first delay unit without time delay;
a second delay unit for transmitting the RF signal transmitted from the first reference unit or the first delay unit to be delayed as much as a second delay time twice as long as the first delay time;
a 12th switching unit for transmitting the RF signal transmitted from the first reference unit or the first delay unit to the second reference unit or the second delay unit; and
an output unit for outputting the RF signal transmitted from the second reference unit or the second delay unit to the outside, wherein
the first delay time is controlled in multiple stages, and the second delay time is controlled in fewer stages than the first delay time is controlled.

5. The method according to claim 4, wherein the first delay unit or the second delay unit includes a first MOS capacitor, an inductor, and a second MOS capacitor, wherein the source and the drain of the first MOS capacitor are connected to the ground, the gate of the first MOS capacitor is connected to the inductor, and the source and the drain of the second MOS capacitor are connected to the ground, and the gate of the second MOS capacitor is connected to the inductor, and by adjusting magnitude of bias voltage applied to the gate of the first MOS capacitor, the first delay time is controlled in multiple stages, and by adjusting magnitude of bias voltage applied to the gate of the second MOS capacitor, the second delay time is controlled in fewer stages than the first delay time is controlled.

6. The method according to claim 5, wherein a first capacitor is disposed between the input unit and the first delay unit to suppress transmission of a signal of a Direct Current (DC) component to the first delay unit, and a 12th capacitor is disposed between the first delay unit and the second delay unit to suppress transmission of a signal of a Direct Current (DC) component to the second delay unit.

7. A fine-tuning method of a true time delay system, the method comprising:
a first reference unit for transmitting an applied RF signal without time delay;
a first delay unit for transmitting the applied RF signal to be delayed as much as a first delay time;
an input unit for transmitting the applied RF signal to the first reference unit or the first delay unit;
a second reference unit for transmitting the RF signal transmitted from the first reference unit or the first delay unit without time delay;
a second delay unit for transmitting the RF signal transmitted from the first reference unit or the first delay unit to be delayed as much as a second delay time twice as long as the first delay time;
a 12th switching unit for transmitting the RF signal transmitted from the first reference unit or the first delay unit to the second reference unit or the second delay unit; and
an output unit for outputting the RF signal transmitted from the second reference unit or the second delay unit to the outside, wherein
the first delay time is controlled in multiple stages, and the second delay time is controlled in more stages than the first delay time is controlled.

8. The method according to claim 7, wherein the first delay unit or the second delay unit includes a first MOS capacitor, an inductor, and a second MOS capacitor, wherein the source and the drain of the first MOS capacitor are connected to the ground, the gate of the first MOS capacitor is connected to the inductor, and the source and the drain of the second MOS capacitor are connected to the ground, and the gate of the second MOS capacitor is connected to the inductor, and by adjusting magnitude of bias voltage applied to the gate of the first MOS capacitor, the first delay time is controlled in multiple stages, and by adjusting magnitude of bias voltage applied to the gate of the second MOS capacitor, the second delay time is controlled in more stages than the first delay time is controlled.

9. The method according to claim 8, wherein a first capacitor is disposed between the input unit and the first delay unit to suppress transmission of a signal of a Direct Current (DC) component to the first delay unit, and a 12th capacitor is disposed between the first delay unit and the second delay unit to suppress transmission of a signal of a Direct Current (DC) component to the second delay unit.

10. A fine-tuning method of a true time delay system, the system comprising:
a first reference unit for transmitting an applied RF signal without time delay;
a first delay unit for transmitting the applied RF signal to be delayed as much as a first delay time;
an input unit for transmitting the applied RF signal to the first reference unit or the first delay unit;
a second reference unit for transmitting the RF signal transmitted from the first reference unit or the first delay unit without time delay;
a second delay unit for transmitting the RF signal transmitted from the first reference unit or the first delay unit to be delayed as much as a second delay time twice as long as the first delay time;
a 12th switching unit for transmitting the RF signal transmitted from the first reference unit or the first delay unit to the second reference unit or the second delay unit;
a third reference unit for transmitting the RF signal transmitted from the second reference unit or the second delay unit without time delay;
a third delay unit for transmitting the RF signal transmitted from the second reference unit or the second delay unit to be delayed as much as a third delay time four times as long as the first delay time;
a 23th switching unit for transmitting the RF signal transmitted from the second reference unit or the second delay unit to the third reference unit or the third delay unit;
a fourth reference unit for transmitting the RF signal transmitted from the third reference unit or the third delay unit without time delay;
a fourth delay unit for transmitting the RF signal transmitted from the third reference unit or the third delay unit to be delayed as much as a fourth delay time eight times as long as the first delay time;
a 34th switching unit for transmitting the RF signal transmitted from the third reference unit or the third delay unit to the fourth reference unit or the fourth delay unit;
a fifth reference unit for transmitting the RF signal transmitted from the fourth reference unit or the fourth delay unit without time delay;
a fifth delay unit for transmitting the RF signal transmitted from the fourth reference unit or the fourth delay unit to be delayed as much as a fifth delay time sixteen times as long as the first delay time;
a 45th switching unit for transmitting the RF signal transmitted from the fourth reference unit or the fourth delay unit to the fifth reference unit or the fifth delay unit; and
an output unit for outputting the RF signal transmitted from the fifth reference unit or the fifth delay unit to the outside, wherein
the first delay time is controlled in multiple stages, the second delay time is controlled in multiple stages, the third delay time is controlled in multiple stages, the fourth delay time is controlled in multiple stages, and the fifth delay time is controlled in multiple stages.

11. The method according to claim 10, wherein the first delay unit, the second delay unit, the third delay unit, the fourth delay unit, or the fifth delay unit includes a first MOS capacitor, an inductor, and a second MOS capacitor, and the source and the drain of the first MOS capacitor are connected to the ground, the gate of the first MOS capacitor is connected to the inductor, the source and the drain of the second MOS capacitor are connected to the ground, and the gate of the second MOS capacitor is connected to the inductor, and by adjusting the magnitude of the bias voltages applied to the gate of the first MOS capacitor and the gate of the second MOS capacitor, the first delay time, the second delay time, the third delay time, the fourth delay time, or the fifth delay time is controlled in multiple stages.

12. The method according to claim 11, wherein a first capacitor is disposed between the input unit and the first delay unit to suppress transmission of a signal of a Direct Current (DC) component to the first delay unit, a 12th capacitor is disposed between the first delay unit and the second delay unit to suppress transmission of a signal of a Direct Current (DC) component to the second delay unit, a 23th capacitor is disposed between the second delay unit and the third delay unit to suppress transmission of a signal of a Direct Current (DC) component to the third delay unit, a 34th capacitor is disposed between the third delay unit and the fourth delay unit to suppress transmission of a signal of a Direct Current (DC) component to the fourth delay unit, and a 45th capacitor is disposed between the fourth delay unit and the fifth delay unit to suppress transmission of a signal of a Direct Current (DC) component to the fifth delay unit.
